(19) United States
(12) Patent Application Publication
(10) Pub. No.: US 2004/0203915 A1
(43) Pub. Date: Oct. 14, 2004

(54) Method and apparatus for locating a mobile receiver having a position cache

(76) Inventors: Frank van Diggelen, San Jose, CA (US); Charles Abraham, Los Gatos, CA (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/349,493

(22) Filed: Jan. 22, 2003

(51) Int. Cl. H04Q 7/20

(52) U.S. Cl. 455/456.1; 342/357.06

(57) ABSTRACT

A method and apparatus that uses a position cache for locating a position of an A-GPS receiver that is embedded in a mobile device. In one embodiment of the invention, the position cache is a look up table comprising cell identification codes and position information. The position information is generally the location of the center of each cell that is identified by a cell identification code in the table. This position information is used as a position estimate for the A-GPS receiver. The method receives a cell identification code from a wireless network, retrieves a position estimate from the a position cache that corresponds to the received cell identification code, then computes a current position of the A-GPS receiver using position location aiding information, certain satellite data and the position estimate of the A-GPS receiver.

### BACKGROUND OF THE INVENTION

1. Field of Invention

The present invention relates to mobile wireless devices as used in object location systems. In particular, the present invention relates to a method and apparatus for utilizing the Global Position System (“GPS”) to locate objects over a large geographic region.

2. Description of the Background Art

In an effort to enhance GPS signal processing, a GPS receiver can be assisted with certain a-priori information. Such assisted GPS (A-GPS) receivers generally are provided with an estimate of the receiver's position and information regarding the satellite constellation (e.g., ephemeris and/or a satellite almanac). The information is provided to the A-GPS receiver via a wireless network such as a cellular telephone network. When operating in a cellular telephone network, the estimate of the receiver's position is generally assumed to be the nearest cellular telephone network tower location or the center location of the cell in which the telephone is operating. To identify the cell in which the receiver is operating, the cellular telephone receives a cell identification code within the cellular telephone signal. This code is coupled to the A-GPS receiver. The A-GPS receiver transmits the cell identification code to a aiding server wherein the server uses the cell identification code to derive an estimated position of the mobile device. The estimated position may then be transmitted to the mobile device. However, the necessity to contact the aiding server every time the mobile device needs a position estimate, increases network traffic and bandwidth utilization.

Therefore, there is a need in the art for an improved method and apparatus for estimating the initial position of an A-GPS receiver.

### SUMMARY OF THE INVENTION

The invention comprises a method and apparatus that uses a position cache that is embedded in a mobile device. In one embodiment of the invention, the position cache is a look up table comprising cell identification codes and position information. The position information is generally the location of the center of each cell that is identified by a cell identification code in the table. This position information is used as a position estimate for the A-GPS receiver. The method receives a cell identification code from a wireless network, retrieves a position estimate from the a position cache that corresponds to the received cell identification code, then computes a current position of the A-GPS receiver using position location aiding information, certain satellite data and the position estimate of the A-GPS receiver.

### BRIEF DESCRIPTION OF DRAWINGS

The teachings of the present invention may be readily understood by considering the following detailed description in conjunction with the accompanying drawings, in which:

FIG. 1 depicts prior art block diagram of an object locating system;

FIG. 2 depicts a block diagram of an embodiment of an object locating system used in accordance with the invention;

FIG. 3 depicts a data flow diagram of an embodiment of the method used in accordance with the invention; and

FIG. 4 depicts an embodiment of a look-up table used in accordance with the invention.

To facilitate understanding, identical reference numerals have been used, where possible, to designate identical elements that are common to the figures.

### DETAILED DESCRIPTION OF THE INVENTION

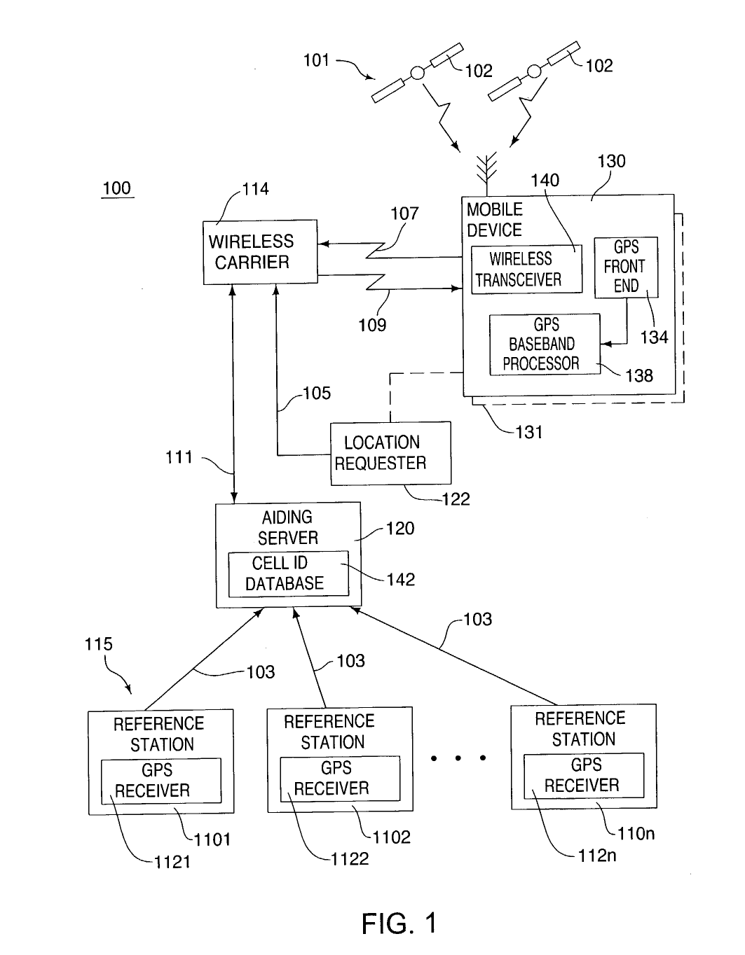

FIG. 1 depicts a block diagram of a location system 100. The system 100 illustratively uses a Global Positioning System (GPS) 101 (or other similar satellite position location system) having a plurality of satellites 102 orbiting the earth. The system 100 comprises a reference station network 115 comprising a plurality of geographically dispersed reference stations where each reference station comprises fixed site GPS receivers 110₁ through 110ₙ (collectively fixed site GPS receiver 110), an aiding server 120 with software that executes GPS signal processing algorithms 120 and at least one mobile device 130. The mobile device 130 is coupled to or otherwise associated with an object that is to be located, e.g., mobile object 131 including personal assets, equipment, persons and the like. The mobile devices 130 communicate with the aiding server 120 via a wireless carrier 114 (e.g., a cellular telephone network). Each reference station 110 further comprises a conventional GPS receiver 112₁ through 112ₙ (collectively conventional GPS receivers 112). For example, for a global network, the network may comprise just a few stations to observe all satellites at all times. Each of the conventional GPS receivers 112 is coupled to the aiding server 120 via a network communications link 103.

The aiding server 120 is utilized to provide the mobile device 130 with satellite aiding information that assists the mobile device in acquiring satellite signals, performing GPS signal measurements and computing position. The aiding information may include, but is not limited to, one or more of satellite ephemeris, long term orbit data, and the like. The aiding server 120 further comprises a cell ID database 142 that is accessed when necessary to supply a geographic position estimate of a wireless carrier cell when provided a cell ID. The mobile device 130 contains a wireless communications transceiver 140 that enables the receiver to communicate with the aiding server 120 through the wireless carrier 114. The wireless carrier communicates with the server through a conventional communication network 111.

As discussed below in detail, the device 130 comprises a wireless transceiver 140, a GPS receiver front end 134, and a GPS signal processor 138. The GPS signal processor 138 includes a highly parallel GPS signal correlator and associated software to perform various algorithms described below. One embodiment of such a correlator is described in commonly assigned U.S. Pat. No. 6,417,801, issued Jul. 9, 2002, which is herein incorporated by reference.

In one embodiment, the mobile device 130 receives aiding data from the aiding server 120 through the wireless link 109, determines a position estimate for the mobile device 130, acquires GPS satellite signals, performs GPS signal measurements and computes position. The mobile device 130 receives a cell identification code from the wireless carrier 114. This cell identification code identifies the cell within which the wireless transceiver 140 is communicating. The cell identification code is used, as described below, to determine the position estimate for the mobile device. The position estimate is used by the mobile device to compute its geographic position. The mobile device 130 may send the computed geographic position through link 107 to the wireless carrier 114. A location requestor 122 can then request the receiver's location through a number of communications paths 105, e.g., dial up access, Internet access, wired land line and the like. The location requester can also be the user of the mobile device in which case location requests could also be communicated through the wireless carrier to the mobile device 130. In various embodiments described herein, the location can be displayed at the mobile device and/or communicated through the wireless carrier 114 to the server 120 or other location requester 122.

The conventional fixed site GPS receivers 112 of the reference station network 115 transmit GPS measurements received from all the visible satellites 102 to the aiding server 120. From these GPS measurements, the aiding server 120 generates aiding data for the mobile device 130. For example, the data may be transmitted through the reference station network 115 via a router and dedicated landline (e.g., ISDN, T1, T2, and the like) or in TCP/IP format over the Internet to a hub at the aiding server 120. The communication network components are represented by links 103. Thereafter, the aiding server 120 is responsible for generating aiding information using, in part, the GPS data transmitted from the reference station network 115.

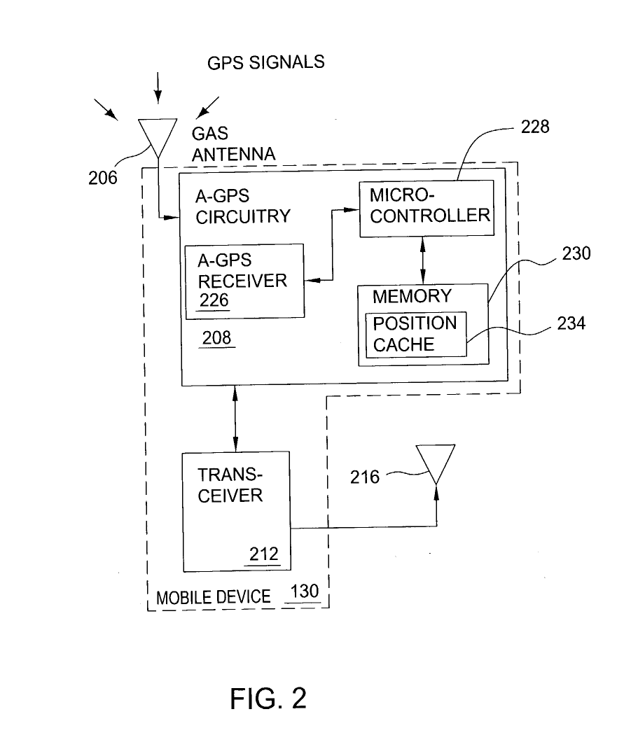

FIG. 2 depicts a block diagram of the mobile device 130 in accordance with one embodiment of the present invention. A-GPS circuitry 208 is contained in the mobile device 130 along with a wireless communication transceiver 212 and an antenna 216. The A-GPS circuitry 208 comprises an A-GPS receiver 226, a microcontroller 228 and a memory 230. The A-GPS receiver 226 processes GPS satellite signals that are received by the antenna 206. The microcontroller 228 measures sub-millisecond pseudo-ranges with respect to GPS satellites that are in view of the mobile device 130, and then, in one embodiment, uses the initial position from a position cache 234 together with the aiding data from the aiding server (120 in FIG. 1) to compute position. In an alternate embodiment, the mobile device 130 sends the pseudoranges to the server which computes position. The pseudo-ranges are computed by the microcontroller 228 after receiving certain ephemeris data or satellite orbit data such as contained in a pseudo-range model from the aiding server. Also, to acquire the satellite signals in order to measure pseudo-ranges, the mobile device requires an estimate of its current position. Such an estimate is available in a position cache 234 within the A-GPS circuitry 208.

The position cache 234 generally stores a position estimate for the mobile device 130 associated With a cell identification code for the cell in which the mobile device previously operated. Each cell of a cellular network has a unique identification code (cell ID) that is used by the wireless network to facilitate handoffs of wireless transceivers as they move from one cell to another. The cell identification code is received by the transceiver 212 and coupled to the A-GPS circuitry 208. When required, the microcontroller 228 will retrieve the position estimate information stored in the cache 234 to use to compute the current location of the mobile device 130. Although the cache 234 is depicted as part of the memory 230, one skilled in the art should appreciate that the memory 254 and the cache 234 may be separate components.

In one embodiment, the cache 234 may be a look-up table. The look-up table may store, for example, a first entry that represents a cell identification code (cell ID) and a second entry that represents a position estimate of the mobile device 130 within that cell. The position is generally the geographic center of the cell or the tower location. As the mobile device 130 is used, the position cache will accumulate a database relating cell IDs to positions. Upon initial use of a cell (i.e., a particular cell identification code does not appear in the lookup table with a corresponding position), the mobile device 130 will request a position from the aiding server by transmitting the cell ID to the server. The aiding server returns a message comprising the cell ID and a position estimate associated with the cell ID as provided by the cell ID database within the aiding server. The position estimate is generally the center of the cell, the tower position or some other position for the cell location in a conventional manner. The cell ID and position estimate are stored in the position cache 234 for future use. As such, once a cell ID is entered into the cache, the aiding server will not have to be contacted for the position estimate when the receiver enters this cell in the future.

In other embodiments of the invention, the position cache may be a priori populated with position information for all cell identification codes of a particular wireless carrier. Periodic updates may be provided by the wireless carrier or aiding server either over-the-air or through an update service (e.g., supply a new database memory chip, download from the Internet, and the like).

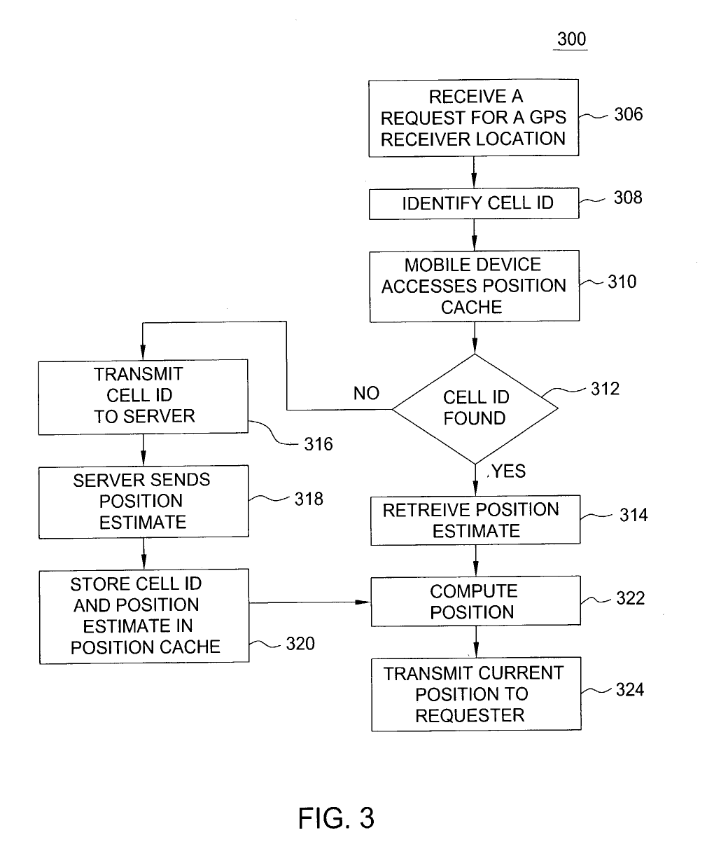

FIG. 3 depicts a flow diagram of an embodiment of a method 300 in accordance with the invention. A party (for example, the user of the mobile device 130) initiates method 300 at step 306 by requesting the location of an A-GPS enabled mobile device. In another embodiment, the request may be a third party. Assuming the request is initiated by the device user, the request initiates position processing in the mobile device. During communication with a base station of the wireless network, the mobile device automatically, at step 308, acquires the cell identification code. The mobile device, at step 310, accesses the position cache 234 to ascertain the position estimate of the mobile device within the identified cell.

At step 312, the method 300 queries whether the cell ID is contained in the cache. If the query is affirmatively answered, the method 300 proceeds to step 314 wherein the position estimate is retrieved from the cache. If the query at step 312 is negatively answered, the position estimate is not available within the cache. Thus, the position estimate must be found from another source (e.g., the cell ID database 142 of the aiding server 120 in FIG. 1). At step 316, the mobile device transmits the cell ID to the server. At step 318, the server sends a position estimate that corresponds to the cell ID to the mobile device. The aiding server maintains a master database of cell IDs and position estimates from which the server extracts the appropriate position information. The position estimates may be a geographic position (e.g., latitude, longitude and elevation) of the center of the cell, the tower position within the cell, or some other position within the cell. At step 320, the cell ID and position estimate are stored in the position cache. As such, the next time a position estimate is needed for this cell ID, the mobile device will have the information available locally.

The mobile device, at step 322, processes satellite data (e.g., pseudo-ranges) and the estimated position of the A-GPS receiver to compute the current position of the A-GPS receiver. The mobile device, at step 324, transmits the current position of the A-GPS receiver to the source of the position request.

In another embodiment, the source of the position request is a third party and the request is routed by a server (the aiding server or some other server) to the mobile device. The computation of position may be performed by the mobile device and relayed through the wireless carrier to the requester. Alternatively, the GPS data collected by the mobile device along with the position estimate may be sent to the aiding server such that the server computes the position of the mobile device and sends the position to the requester.

The position cache 234 enables the server to quickly access initial position information for use in the position computation. The use of a position cache reduces network traffic by not requiring the mobile device to request an estimated position each time a position computation is to be performed.

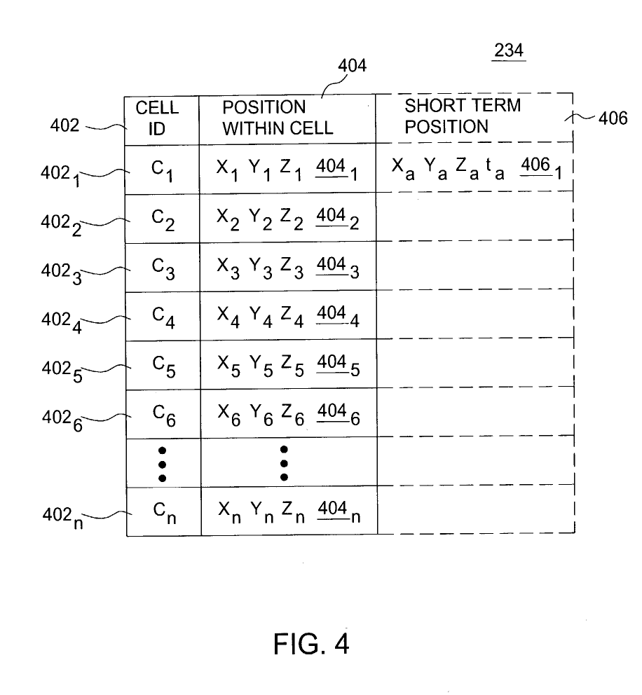

FIG. 4 depicts an embodiment of a position cache 234 used in accordance with the invention. The position cache 234 comprises a first array of registers or fields 402 for storing cell identification codes, a second array of registers or fields 404 for storing position information associated with a cell identification code and, optionally, a third array of registers or fields 406 for storing short term position information. When the mobile device 130 communicates with a base station of the wireless network, the mobile device automatically ascertains the cell identification associated with the base station. The position cache 234, here depicted as a lookup table, checks to see whether the mobile device has ever communicated with a cell having the current cell identification code. If the A-GPS circuitry finds the current cell identification code already stored within the position cache 234, then the mobile device has, in the past, used a base station having this corresponding cell identification code and can use the position stored in the second array of registers 404 for the estimated position. For example, the mobile device is in communication with a base station having a cell identification code that the A-GPS circuitry has found already exists in cell identification register 402₁. The A-GPS circuitry takes the corresponding position stored in register 404, (x₁y₁z₁) and uses this position as the estimated position to determine the current position of the mobile device 130. In some applications, only x and y coordinates are stored. The z coordinate is not generally necessary for the initial position estimate. If the A-GPS circuitry determines that the cell identification code is not in register array 402, then the A-GPS circuitry deems this a null code. The A-GPS circuitry transmits the cell identification code to the aiding server 120. The aiding server 120 sends a position estimate associated with the transmitted cell identification code. The A-GPS circuitry stores the cell identification code and the associated position estimate in their respective array registers 402 and 404. The addition of cell identification codes and their corresponding position estimate occurs each time the mobile device communicates with a cell identification code not already stored in the position cache 234.

In another embodiment, the position cache 234 includes a third array of registers or fields 406 that stores short term position information. The short term position information is the last known position 406₁ in the cell for the mobile device. In some situations, the short term position information may be more accurate an estimate of mobile device position than, for example, the center of the cell. As such, each time the A-GPS circuitry computes the current position of the mobile device, the current position (XₐYₐZₐ) is stored as short term position information 406₁ along with the time tag to that indicates when the computation was performed. If the mobile device reenters a cell within a short period of time, e.g., five minutes, it is assumed that the device is reentering at the same position the device left the cell. One skilled in the art understands that a short period of time term is relative and that different durations may be used for different circumstances. If a position requester requests a position of the mobile device and the mobile device has computed a position in the cell within the last five minutes, then the A-GPS circuitry uses the position from register array 406 as the estimated position for acquisition of the current position.

Although various embodiments, which incorporate the teachings of the present invention have been shown and described in detail herein, those skilled in the art can readily devise many other varied embodiments that still incorporate these teachings.

What is claimed is:

1. A method for locating a position of an A-GPS receiver comprising:
receiving a cell identification code; and
retrieving, from a position cache, a position estimate for said A-GPS receiver that corresponds to said cell identification code, where said A-GPS receiver and said position cache are within a mobile device.

2. The method of claim 1 further comprising computing a current position of said A-GPS receiver using position location aiding information, satellite signals and said position estimate.

3. The method of claim 1 wherein said cell identification code is not found in said position cache said method further comprises:
transmitting said cell identification code to a aiding server;
associating a position estimate with the cell identification code;
transmitting the cell identification code and an associated position estimate from the aiding server to the mobile device;
receiving said cell identification code and an associated position estimate; and
storing said cell identification code and said associated position estimate in said position cache.

4. The method of claim 1 wherein said position cache comprises a look-up table.

5. The method of claim 4 wherein the lookup table comprises a first entry for said cell identification code and a second entry for said position estimate.

6. The method of claim 5 wherein said lookup table further comprises a third entry for short term position information.

7. The method of claim 6 wherein said short term position information is a position of the mobile device that was computed within a previous five minutes.

8. The method of claim 4 further comprises identifying a cell identification code for a cell of a cellular communications network within which the A-GPS receiver is operating.

9. The method of claim 1 wherein the position estimate is a location of a center of a cell in a wireless network, a location of a tower within the cell, or another location within the cell.

10. The method of claim 1 wherein the position estimate is the last known position of the A-GPS receiver within a cell identified by the cell identification code.

11. A mobile device comprising:
an A-GPS receiver; and
a position cache for storing a position estimate for the mobile device and a related cell identification code for a cell of a wireless network.

12. The mobile device of claim 11 wherein said position cache comprises a look-up table.

13. The mobile device of claim 11 wherein the lookup table comprises a first entry for a cell identification code and a second entry for a position estimate.

14. The mobile device of claim 13 wherein the first entry and second entry are created and stored for each cell of a cellular communications network that the mobile device uses for communication.

15. The mobile device of claim 14 wherein the lookup table further comprises a third entry for short term position information.

16. The mobile device of claim 15 wherein said short term position information is a position of the mobile device that was computed within a previous five minutes.

17. The mobile device of claim 11 wherein the position estimate is a location of a center of a cell in a wireless network, a location of a tower within the cell, or another location within the cell.

18. The mobile device of claim 11 wherein the position estimate is the last known position of the A-GPS receiver within a cell identified by the cell identification code.

19. A system for locating positions of mobile devices comprising:
at least one mobile device comprising an A-GPS receiver, a position cache and a wireless transceiver, where the position cache stores a position estimate for the mobile device and a related cell identification code for each cell of a wireless network that may be or was used by the at least one mobile device; and
a server in wireless communication with the mobile device.

20. The system of claim 19 wherein the wireless transceiver comprises a cellular telephone transceiver.

21. The system of claim 19 wherein said position cache comprises a look-up table.

22. The system of claim 21 wherein the lookup table comprises a first entry for a cell identification code and a second entry for a position estimate.

23. The system of claim 22 wherein the lookup table further comprises a third entry for short term position information.

24. The system of claim 23 wherein said short term position information is a position of the mobile device that was computed within a previous five minutes.
